(19) United States
(12) Patent Application Publication
(10) Pub. No.: US 2007/0081873 A1
(43) Pub. Date: Apr. 12, 2007

(54) Milling cutter head and a milling cutter tool

(75) Inventors: Per Blomstedt, Gavle (SE); Ralf Lehto, Gavle (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/540,978

(22) Filed: Oct. 2, 2006

(30) Foreign Application Priority Data
Oct. 5, 2005 (SE) 0502206-6

(51) Int. Cl. B23C 5/00

(52) U.S. Cl. 409/234

(57) ABSTRACT

A milling cutter head in the form of a body, which has an external envelope surface having a rotationally symmetrical basic shape in respect of a central axis, and includes a plurality of peripherally spaced-apart cutting edges and chip flutes. The cutter head includes two axially spaced-apart ends in which hollow spaces open, which are arranged to receive male elements included in a basic body, and are spaced-apart by a partition wall in which a through hole is formed. The through hole mouths in bottom surfaces in the hollow spaces. The cross-section area of each individual hollow space, in a plane perpendicular to the center axis, amounts to at least 25% of the total cross-section area of the body, as defined by the greatest diameter of the envelope surface.

This application claims priority under 35 U.S.C. § 119 to Swedish Patent Application No. 0502206-6, filed on Oct. 5, 2005, the disclosure of which is incorporated by reference herein in its entirety.

### FIELD OF THE INVENTION

The present invention relates generally to a replaceable milling cutter head in the form of a body, which has, on one hand, an external envelope surface, which has a rotationally symmetrical basic shape in respect of a central axis, and includes a plurality of peripherally spaced-apart cutting edges and chip flutes, and, on the other hand, two axially spaced-apart front and rear ends in which hollow spaces open, which are arranged to receive male elements included in a basic body, and spaced-apart by a partition wall in which a through hole is formed, which mouths in bottom surfaces in the hollow spaces. The present invention also relates generally to a milling cutter tool having such a milling cutter head.

### BACKGROUND OF THE INVENTION

Replaceable milling cutter heads of the type that include integrated cutting edges and are detachably connectable with a basic body of the tool, are frequently constructed with cutting edges that extend the entire way (or the major part of the way) between the front and rear ends of the milling cutter head. However, long cutting edges are rarely utilized even along the major part of the length thereof. On the contrary, at small (and fairly usually occurring) cutting depths, only limited portions of the cutting edges are utilized, viz. the front edge portions that cut into the workpiece and separate chips from the same. Thus, in fine milling, for instance, it occurs that only 1-10% of the entire edge length become worn, while 90-99% remain unutilized. For this reason, there is a need for indexable milling cutter heads of twice the service life.

Proposals for milling cutter tools have recently been made, the milling cutter heads of which are made in a single piece of cemented carbide, the requisite cutting edges being formed in the proper cemented carbide body (contrary to such cutting edges that are included in separate cemented-carbide inserts, which individually are detachably connected with a milling cutter head of steel). Such milling cutter heads of cemented carbide having integrated cutting edges are commonly denominated loose tops, in particular when they are included in small milling cutters, such as shank-end mills, contour mills and the like. Examples of milling cutter tools that make use of such loose tops are found in the following patent documents: WO 03/097281, WO 03101650, EP 0911101, EP 1237670, EP 1342521, DE 3230688, U.S. Pat. No. 6,241,433, U.S. Pat. No. 6,276,879, U.S. Pat. No. 6,494,648 and U.S. Pat. No. 6,497,540.

In one of these patent documents, viz. U.S. Pat. No. 6,497,540, the general idea has been presented of making the milling cutter head or the loose top in a contour mill, in such a way that the milling cutter head can be indexed with the purpose of doubling the service life. In FIG. 9 of U.S. Pat. No. 6,497,540, an approximately globular milling cutter head is shown having two diametrically opposed ends in which hollow spaces open, which are spaced-apart by a central partition wall in which a through hole is formed for a fixing screw. By the existence of two such hollow spaces, a head of the fixing screw should be possible to be housed inside the milling cutter head irrespective of which one of the two ends that is connected to the rotatable basic body of the tool. These utmost scanty teachings are, however, only of theoretical character, so far that the document lacks any teaching of how the milling cutter head in practice could be detachably connected to the basic body in a stable and reliable way. Among other things, any means to transfer torque from the basic body to the milling cutter head is lacking in the construction. The teachings of U.S. Pat. No. 6,497,540 cannot be utilized by a person skilled in the art to construct practically useful milling cutter tools having indexable milling cutter heads.

The present invention aims at obviating the above-mentioned shortcomings of the milling cutter tool of U.S. Pat. No. 6,497,540, and at providing an improved, practically useful milling cutter tool having an indexable milling cutter head. Therefore, an object of the invention, in a first aspect, is to provide a milling cutter head that, on one hand, can be fixed in a stable and exact way on the basic body of the tool, and on the other hand has an interface acting against the basic body via which interface considerable torques can be transferred from the basic body to the milling cutter head, without the same skidding or being dislodged from the desired position thereof.

Another object of the invention is to provide a milling cutter head having a geometry that allows the formation of a large number of cutting edges located close to each other as well as the appurtenant chip flutes.

Yet another object of the invention is to provide a milling cutter head that is particularly suitable for fine milling at small cutting depths.

Still another object of the invention to provide a cemented carbide milling cutter head that is simple and inexpensive to manufacture by means of known manufacturing methods, e.g. compression-moulding and sintering. In this connection, the milling cutter head should also be possible to be finished in a simple way.

The invention also relates to a milling cutter tool, which in the assembled state includes a milling cutter head as well as a basic body. An object of the invention in this respect is to provide a milling cutter tool, the interface of which between the basic body and the milling cutter head is formed in such a way that the holding of the milling cutter head in the desired position becomes reliable, stable and exact in a repeatable way.

Another object of the invention is to provide a milling cutter tool, the milling cutter head of which does not run the risk of coming loose from the basic body as a consequence of failing holding functions.

### SUMMARY OF THE INVENTION

In an embodiment, the invention provides a milling cutter head in the form of a body, which has an external envelope surface having a rotationally symmetrical basic shape in respect of a central axis, and includes a plurality of peripherally spaced-apart cutting edges and chip flutes. The cutter head includes two axially spaced-apart ends in which hollow spaces open, which are arranged to receive male elements included in a basic body, and are spaced-apart by a partition wall in which a through hole is formed. The through hole mouths in bottom surfaces in the hollow spaces. The cross-section area of each individual hollow space, in a plane perpendicular to the center axis, amounts to at least 25% of the total cross-section area of the body, as defined by the greatest diameter of the envelope surface.

In another embodiment, the invention provides a milling cutter tool, including a rotatable basic body and a replaceable milling cutter head. The milling cutter head has an external envelope surface having a rotationally symmetrical basic shape in respect of a central axis around which the body is rotatable, and includes a plurality of peripherally spaced-apart cutting edges and chip flutes. The cutter head includes two axially spaced-apart ends in which hollow spaces open, one of which engages a male element included in the basic body. The male element has a cross-section shape that is complementary with the cross-section shape of the hollow space. The hollow spaces are spaced-apart by a partition wall in which a through hole is formed, which mouths in bottom surfaces in the hollow spaces. The milling cutter head is fixable on the basic body by means of a tightening device. The cross-section area of each individual hollow space amounts to at least 25% of the total cross-section area of the body, as determined by the greatest outer diameter of the body.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a partial perspective view of a milling cutter tool according to the invention composed of a basic body and a milling cutter head;

FIG. 2 is a perspective exploded view showing the basic body and the milling cutter head spaced-apart from each other and from a tightening device in the form of a screw;

FIG. 3 is an enlarged plan view as viewed from an arbitrary end of the milling cutter head;

FIG. 4 is a section A-A in FIG. 3;

FIG. 5 is a side view of the milling cutter head;

FIG. 6 is an exploded view partly in section showing the basic body, the milling cutter head and the tightening screw spaced-apart from each other; and

FIG. 7 is a perspective view showing an alternative embodiment of a cutter head according to the invention.

### DETAILED DESCRIPTION OF THE PREFERRED EMBODIMENTS

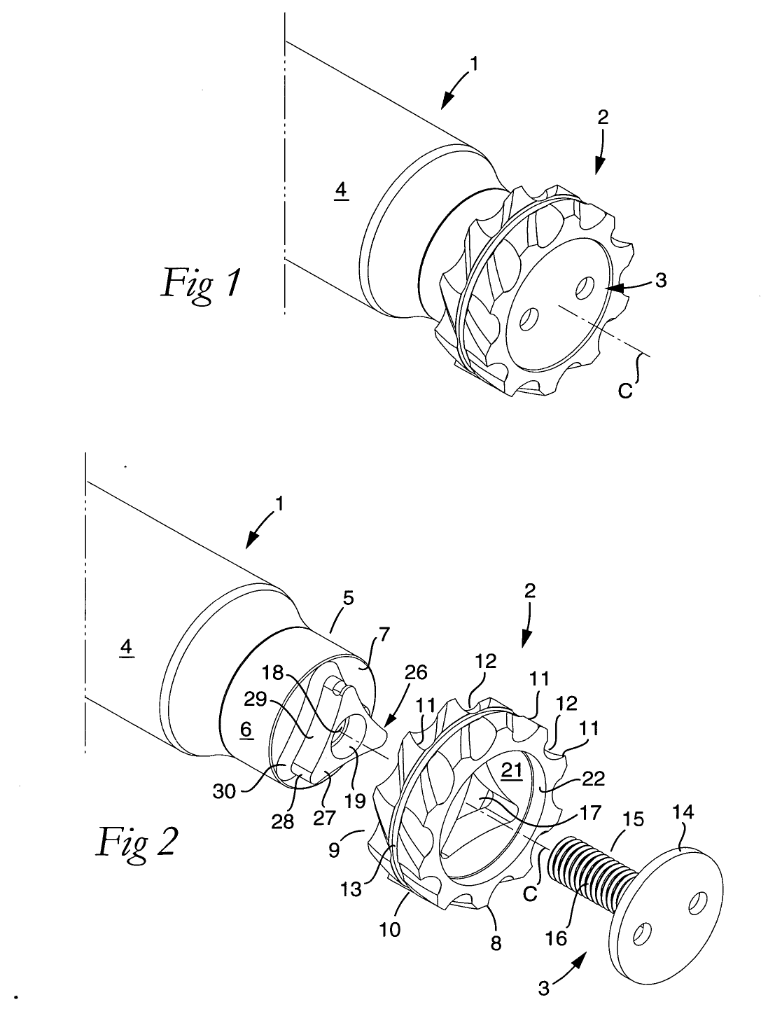

In FIGS. 1 and 2, a milling cutter tool made in accordance with the invention is shown, and which is composed of a rotatable basic body 1 and a replaceable milling cutter head 2. For the fixation of the milling cutter head on the basic body, a tightening device 3 is used, which in the embodiment shown is in the form of a screw mounted from the front. In the example, not only the milling cutter head 2, but also the basic body 1, has a rotationally symmetrical basic shape defined by a central axis C around which the tool is rotatable. Advantageously—though not necessarily—the basic body 1 has an elongate shape, and is, in this case, delimited along the major part of the length thereof by a cylindrical envelope surface 4. At the front, free end thereof, the basic body transforms into a thinner, male-like member 5, which is delimited by a rotationally symmetrical envelope surface 6, as well as a planar end surface 7. Most suitably, the envelope surface 6 is cylindrical.

The milling cutter head 2 has opposite ends 8, 9, between which a generally rotationally symmetrical envelope surface 10 extends. In the envelope surface, a plurality of peripherally spaced-apart cutting edges 11 are formed, between which there are chip flutes 12. Thus, although the envelope surface is not smooth, the same has, however, in respect of geometry, a rotationally symmetrical basic shape, which may be, for example, entirely or partly cylindrical, conical or arched. In the example shown, the milling cutter head is formed with two axially spaced-apart sets or rims of cutting edges, which are spaced-apart by a waist 13 in the form of a smooth, circumferential surface. Most suitably, the cutting edges are equidistantly spaced-apart along the circumference of the milling cutter head.

The tightening screw 3 includes a head 14, as well as a shank 15 having a male thread 16. In the cutter head, a central, through hole 17 is formed, through which the shank 15 can pass in order to be tightened in a female thread 18 in a central hole 19, which mouths in the front end of the basic body.

In practice, the milling cutter head may be composed of a body that is made in a single piece of a hard, wear-resistant material, such as cemented carbide, ceramics, cermet or the like. To that extent, the milling cutter head may be said to be composed of a hard, wear-resistant loose top, which is mountable on a basic body of a softer or more elastic material, such as steel.

In order to meet the desire about long service life, the shown milling cutter head is indexable by including two diametrically opposed, identical hollow spaces 20, which open in the ends 8, 9.

In contrast to known tools, the tool according to the invention is, however, made in such a way that it is suitable for practical use, as is seen from the following description.

Each individual hollow space 20 is delimited by a bottom surface 21 and an endless, circumferential limiting surface 22. Around the hollow space, a ring-shaped end surface 23 extends, which together with the endless surface 22 and the external envelope surface 10 delimits a ring- or rim-shaped part 24. In the preferred embodiment, the surface 22 is rotationally symmetrical, suitably cylindrical, while the bottom surface 21 is planar and extends perpendicularly to the center axis C. Also the individual end surface 23 may advantageously be planar and smooth.

In FIG. 4, D1 designates the greatest outer diameter of the milling cutter head, while L designates the length thereof, as determined by the axial distance between the planar end surfaces 23 at the opposite ends of the milling cutter head. In order to enable indexing of the milling cutter head, the two hollow spaces 20 are identical, at least in respect of the diameter D2, and advantageously also in respect of the axial depth. The inner diameter D2 corresponds in all essentials with the outer diameter (see FIG. 1) of the male element 5. However, between the contact surfaces 6, 22, a fine fit may be present, e.g., within the range of 0.01-0.05 mm.

Characteristic of the milling cutter head according to the invention is that the cross-section area of the individual hollow space 20, in a plane perpendicular to the center axis C, amounts to at least 25% of the total cross-section area of the body, as determined by the outer diameter D1. This means that the inner diameter D2 of the hollow space shall amount to at least 50% of the outer diameter D1. On the other hand, the inner diameter D2 should not exceed 85% of the outer diameter D1. In the example shown, the diameter D2 amounts to about 70% of the diameter D1. Advantageously, the ratio D2/D1 may be within the range of 0.6-0.8, or 0.65-0.75.

In this connection, it should, however, be pointed out that the hollow space 20, and the co-operating male element 5 of the basic body, not of necessity must have a rotationally symmetrical shape. Thus, the male element and the individual hollow space may also be imparted out of round cross-section shapes, e.g., polygonal or in another way irregular shapes, provided that said shapes are at least partially complementary.

In the preferred embodiment shown in FIGS. 1-6, the milling cutter head has a flat, pulley-like shape so far that the axial distance L between the end surfaces 23 is at most half as large as the outer diameter D1. In the example, the length L amounts to ⅓ (33%). However, the ratio L/D1 may vary most considerably within the range below 0.5. However, the ratio should not be below 0.15. In practice, a ratio L/D1 within the range of 0.2-0.4, suitably 0.3-0.35, is preferred.

In the example, the ring-shaped part 24 that surrounds each hollow space 20 is equally thick along the entire circumference thereof, more precisely by the fact that the inner, cylindrical surface 22 is concentric with the external envelope surface 10. Between the two bottom surfaces 21, a material portion designated 25 is delimited, which forms a central frame or partition wall between the hollow spaces 20. The thickness of said partition wall (see FIG. 4) is designated T1, while the axial depths of the hollow spaces 20 are designated T2 and T3, respectively. As is clearly seen in FIG. 4, the thickness T1 of the partition wall 25 is greater than the depth, T2, T3 of the individual hollow space 20. Advantageously—though not necessarily, the depths T2, T3 of the two hollow spaces 20 are equally large.

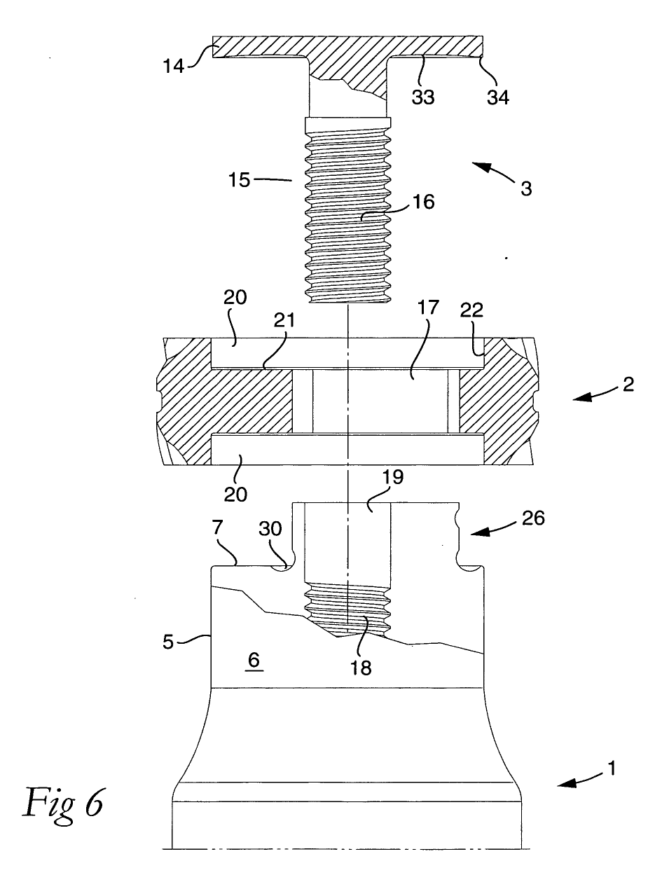

Now reference is made again to FIG. 2, which shows that a driver 26 is formed on the planar end surface 7 of the male element 5. Said driver has a cross-section-wise out of round shape, which in practice may be realized in different ways. However, in the example, a generally triangle-like shape has been selected having three equidistantly (120°) spaced-apart tips or corners. More precisely, the driver 26 is delimited by a planar end surface 27, three convexly arched or rounded surfaces 28 at the corners, as well as three concavely arched side surfaces 29 between the corners. Between the proper driver body and the end surface 7 of the male element 5, a narrowed waist 30 is formed (see also FIG. 6), which separates the inner edge of the corner and side surfaces 28, 29 of the driver from the end surface 7.

In the shown, preferred embodiment, the through hole 17 through the partition wall 25 is utilized as a female-like seat for the receipt of the driver 26. For this reason, in this case the hole 17 has been given a generally triangular shape corresponding to the triangular shape of the driver 26. The endless hole-edge surface that delimits the hole 17 includes therefore three concavely arched surfaces 31 located corner-wise, as well as three side surfaces 32 extending between the same and having an convexly arched shape. The fit between, on one hand, the surfaces 28, 29, and on the other hand the surfaces 31, 32, should be fine, e.g., within the range of 0.01-0.05 mm. For the sake of completeness, it should be pointed out that imaginary generatrices, which geometrically generate said surfaces, are parallel to the center axis C.

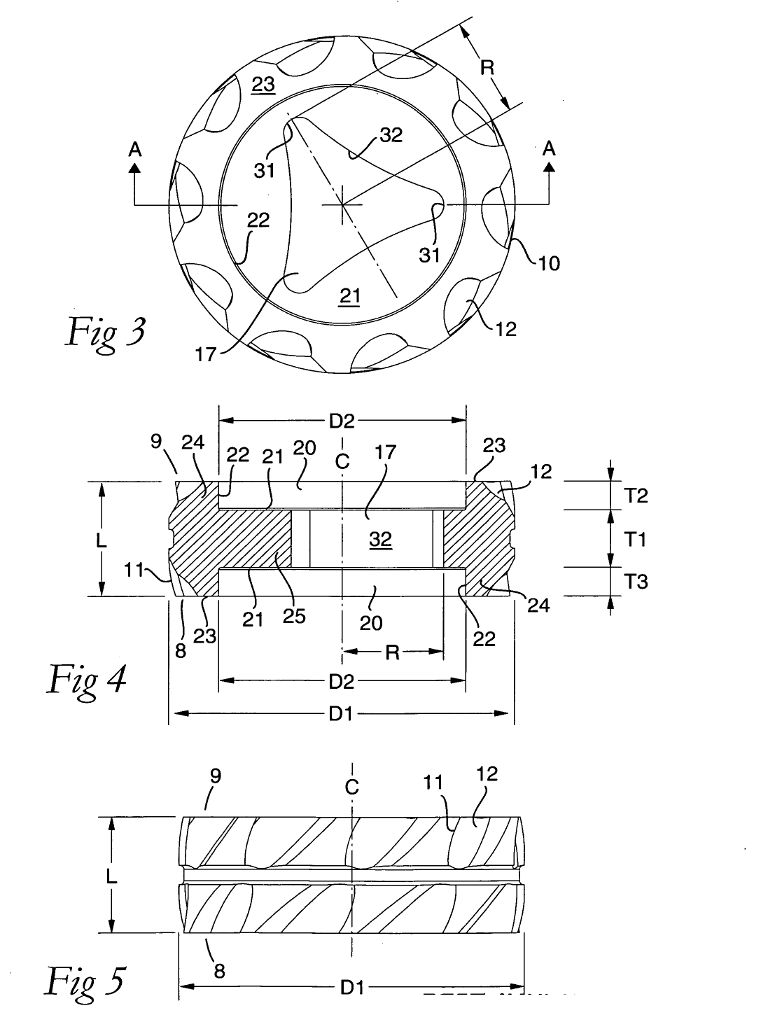

An important feature of the described milling cutter head is that the driver 26 and the co-operating seat, i.e., the hole 17, has a considerable radial extension. In FIG. 3, R designates the greatest radial extension of the seat 17, such as this is determined by the distance between the center axis C and the concavely arched corner surface 31 of the hole-edge surface. In the example shown, the radius R amounts to about 60% of the radius (D1/2) of the external envelope surface 10. This relatively large radial measure, which is enabled by the fact that the hollow space 20 has an even greater radius, guarantees that the torque arm for the transfer of torque from the basic body 1 to the milling cutter head 2 becomes advantageously large.

Before the invention is further described, it should be pointed out that the means for the transfer of torque to the milling cutter head also may be made in other ways than in the form of an out of round driver of the basic body and an out of round seat in the milling cutter head, and that it is neither necessary to utilize the hole 17 as a seat. On the contrary, an object of the hole 17 is to allow the shank 15 of the screw 3 serving as a tightening device to pass through the milling cutter head and be drawn into the basic body 1 during clamping of the milling cutter head. Against this background, it is feasible to give the hole 17 a conventional, cylindrical shape, at the same time as the transfer of torque is provided in another way. For instance, one or more projections (not shown) retreated radially from the center axis may be inserted into a corresponding number of seats, which open in the bottom surface 21. Conversely, it is feasible to form such projections on the milling cutter head at the same time as co-operating seats are formed in the basic body.

It is important for the stability of the milling cutter head 2 on the basic body 1 that the male element 5 protrudes a distance into the hollow space 20 in question in the milling cutter head 2, wherein the envelope surface 6 of the male element should have a fine fit (0.01 to 0.05 mm) against the inner limiting surface 22 of the hollow space. This means that the shown driver 26 could be spared, if the transfer of torque is provided in another way. In this connection, it should be pointed out that the surfaces contacting each other in the composed state of the tool, viz. the surface pairs 7, 21 and 6, 22, both have a radial extension or range that is considerable in relation to the outer diameter of the milling cutter head. This ensures that the fixation of the milling cutter head on the basic body becomes stable and reliable, also in case the tool is subjected to most varying combinations of axial and radial cutting forces.

Two other factors, which both relates to the tightening screw 3, also contribute significantly to the stable fixation of the milling cutter head. In the embodiment shown in FIG. 2, the milling cutter head 2 is right-hand cutting. Simultaneously, the screw 3 is right-threaded. This means that the screw upon tightening brings the milling cutter head to be angularly displaced (some hundredths of a millimeter) in such a way that the parts of the hole-edge surface, against which torque is to be transferred from the corresponding part surfaces of the driver 26, are put in close contact to the same. Therefore, when the milling cutter head enters a workpiece, this takes place without the same rattling or moving vis-à-vis the basic body. In the case of left-hand cutting milling cutter heads, the same effect is attained by using a left-threaded screw.

The second factor is illustrated in FIG. 6, from which it is seen that the head 14 of the screw is in the form of a resilient brim having a diameter that is considerably greater than the thickness of the brim. Furthermore, on the underside thereof, the brim is formed with a concavely arched surface 33 inside a peripheral, circumferential surface or contact line 34. When the screw is tightened in the female thread 18 of the basic body 1, the head or the brim 14 will be pressed only with the contact surface 34 against the planar bottom surface 21 of the hollow space 20, the brim springing elastic in order to continuously apply a spring bias to the milling cutter head. By the elasticity or flexibility of the brim, it is guaranteed that the milling cutter head is kept in place, even if the tool would be subjected to vibrations or other outer stresses that aim to loosen the screw.

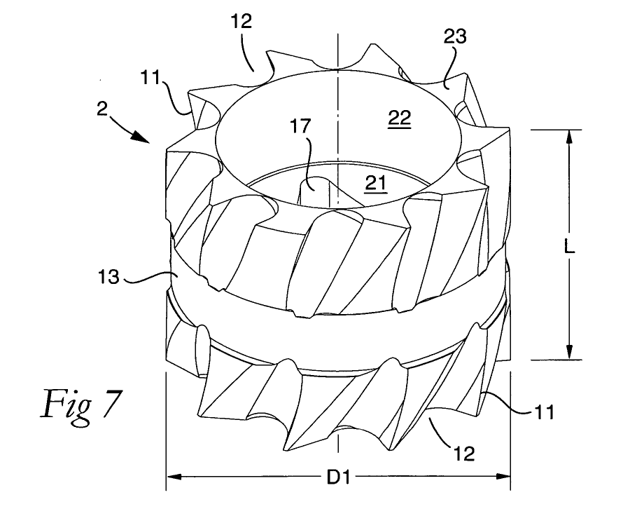

Reference is now made to FIG. 7, which illustrates an alternative embodiment of a milling cutter head according to the invention. This embodiment differs from the preceding only in that the same has a greater axial extension L. Thus, in the example, the ratio L/D1 is about 0.7. Also in this case, the milling cutter head 2 includes opposite hollow spaces having one and the same diameter or cross-section area, so that the same can be indexed in the way described above.

By having been formed with radially ample, hollow spaces for the receipt of a thick, robust male element of the basic body, the milling cutter head according to the invention offers a number of advantages above previously known milling cutter heads. Thus, a very stable and exact fixation of the cutter head on the rotatable basic body is guaranteed, since, on one hand, the planar contact surfaces have a large radial extension, and on the other hand the rotationally symmetrical or endless contact surfaces are situated at a large radial distance from the center axis. Furthermore, by the fact that the hollow spaces have a large radial extension, the possibility of constructing the tool with driver members is offered, which in turn are radially far retreated from the center axis, something which in turn ensures that large torques can be transferred from the basic body to the milling cutter head by means of moderate forces in the interfaces between the contact surfaces. Furthermore, the flat, pulley-like basic shape of the first described cutter head allows the formation of a large number of cutting edges located close to each other, which are not unnecessary long and thereby not unnecessary expensive. This is particularly attractive in connection with milling at small or moderate cutting depths, such as in fine milling or the like.

While the invention has been disclosed with reference to certain preferred embodiments, numerous modifications, alterations, and changes to the described embodiments are possible without departing from the sphere and scope of the invention, as defined in the appended claims and their equivalents thereof. For example, as has been indicated above, it is feasible to form one or more projections on the bottom surface in the hollow spaces of the milling cutter head, and let said projections co-operate with holes or seats in the planar end surface of the basic body. Important for the stability of the milling cutter head is that the front portion of the basic body projects a distance into the radially ample, hollow spaces of the milling cutter head, and not whether the means for the transfer of torque are one or more male-like members placed on the basic body and co-operating with seats in the milling cutter head. Furthermore, in this context, it should be pointed out that the transfer of torque also may be provided by the fact that the circumferential contact surface 6 on the male element of the basic body, which co-operates with the inner, endless contact surface 22, is made with an out of round, e.g., polygonal shape, at the same time as the surface 22 is given a complementary shape. Furthermore, for the fixation of the milling cutter head on the basic body, it is feasible to use other tightening devices than a screw having a male thread. Thus, a drawbar without a thread may be used, which is drawn into the basic body by other suitable means, e.g., an eccentric mechanism or the like. Also such a drawbar may advantageously be constructed with a resilient head of the type included in the shown tightening screw. In conclusion, it should be pointed out that the cutting edges and the chip flutes, respectively, of the milling cutter head not necessarily have to be formed in two axially spaced-apart, rim-shaped sets such as has been exemplified in the drawings. Thus, the cutting edges and the chip flutes may extend continuously all the way between the opposite ends of the milling cutter head. Accordingly, it is intended that the invention not be limited to the described embodiments, but that it have the full scope defined by the language of the following claims.

What is claimed is:

1. A milling cutter head in the form of a body, which has an external envelope surface having a rotationally symmetrical basic shape in respect of a central axis, and includes a plurality of peripherally spaced-apart cutting edges and chip flutes, and two axially spaced-apart ends in which hollow spaces open, which are arranged to receive male elements included in a basic body, and are spaced-apart by a partition wall in which a through hole is formed, which mouths in bottom surfaces in the hollow spaces, wherein the cross-section area of each individual hollow space, in a plane perpendicular to the center axis, amounts to at least 25% of the total cross-section area of the body, as defined by the greatest diameter of the envelope surface.

2. The milling cutter head according to claim 1, wherein each individual hollow space, in addition to said bottom surface, is delimited by an endless limiting surface on the inside of a ring-shaped part of the body, at least one female seat mouthing in the bottom surface.

3. The milling cutter head according to claim 2, wherein the seat defines an out of round cross-section shape.

4. The milling cutter head according to claim 3, wherein the through hole through the partition wall has an out of round cross-section shape and forms the female seat.

5. The milling cutter head according to claim 2, wherein the ring-shaped part is equally thick along the entire circumference thereof, such that the inner, endless limiting surface is rotationally symmetrical and concentric with the envelope surface of the cutter head.

6. The milling cutter head according to claim 5, wherein the endless limiting surface is cylindrical.

7. The milling cutter head according to claim 1, wherein the end surface of the body that surrounds each individual hollow space is in the form of a planar, ring-shaped surface, which extends in a plane perpendicular to the center axis.

8. The milling cutter head according to claim 1, wherein the partition wall extends in a cross-plane perpendicular to the center axis, which cross-plane is located halfway between the two ends of the body.

9. The milling cutter head according to claim 1, wherein the thickness of the partition wall is greater than the axial depth of each individual hollow space.

10. The milling cutter head according to claim 1, wherein the cutter head has a flat, pulley-like basic shape, so far that the axial distance between the two ends of the body is at most half as large as the greatest outer diameter of the body.

11. A milling cutter tool, comprising a rotatable basic body and a replaceable milling cutter head, which has an external envelope surface having a rotationally symmetrical basic shape in respect of a central axis around which the body is rotatable, and includes a plurality of peripherally spaced-apart cutting edges and chip flutes, and two axially spaced-apart ends in which hollow spaces open, one of which engages a male element included in the basic body, said male element having a cross-section shape being complementary with the cross-section shape of the hollow space, said hollow spaces being spaced-apart by a partition wall in which a through hole is formed, which mouths in bottom surfaces in the hollow spaces, the milling cutter head being fixable on the basic body by means of a tightening device, wherein the cross-section area of each individual hollow space amounts to at least 25% of the total cross-section area of the body, as determined by the greatest outer diameter of the body.

12. The milling cutter tool according to claim 11, wherein the male element is rotationally symmetrical, and has an end surface in which a hole mouths having a female thread for the receipt of a male thread of a screw serving as the tightening device.

13. The milling cutter tool according to claim 12, wherein on the end surface of the male element, at least one driver is formed, which engages a seat in the partition wall of the milling cutter head.

14. The milling cutter tool according to claim 12, wherein the cutting edges of the milling cutter head are right-hand cutting and the screw simultaneously right-threaded so that the screw upon tightening should press adequate contact surfaces in the seat against torque-transferring contact surfaces of the driver.

15. The milling cutter tool according to claim 12, wherein the cutting edges of the milling cutter head are left-hand cutting and the screw simultaneously left-threaded so that the screw upon tightening should press adequate contact surfaces in the seat against torque-transferring contact surfaces of the driver.

16. A milling cutter head, symmetrically disposed about a longitudinal central axis, comprising:
an external envelope surface including a plurality of peripherally spaced-apart cutting edges and chip flutes;
two axially spaced-apart ends;
a hollow space opening in each end, adapted to receive a male element of a basic body;
a partition wall between the ends; and
a through hole formed in the partition wall that mouths in bottom surfaces of the hollow spaces,
wherein the cross-sectional area of each hollow space, in a plane perpendicular to the central axis, is at least 25% of the total cross-sectional area of the cutter head, as defined by the greatest diameter of the envelope surface.
